(19) United States
(12) Patent Application Publication
(10) Pub. No.: US 2018/0232112 A1
(43) Pub. Date: Aug. 16, 2018

(54) MESSAGING SYSTEM WITH LOCATION TRACKING

(71) Applicant: Sheng-Chun Lin, New Taipei City (TW)

(72) Inventor: Sheng-Chun Lin, New Taipei City (TW)

(21) Appl. No.: 15/430,543

(22) Filed: Feb. 13, 2017

(51) Int. Cl. G06F 3/0482; H04M 1/725; G01C 21/34; G01C 21/36

(52) U.S. Cl. CPC G06F 3/0482; H04M 1/72572; G01C 21/367; G01C 21/3676; G01C 21/3697; G01C 21/3438

(57) ABSTRACT

The messaging system includes a map unit and a messaging unit. The map unit provides and shows the locations of a local user and at least a correspondent. The messaging unit provides two-way communications between the local user and the correspondent. The displays from the map unit and the messaging unit are integrated in a same screen so that the local user and the correspondent may learn the whereabouts of the other party while conducting communications simultaneously.

### BACKGROUND OF THE INVENTION

### (a) Technical Field of the Invention

The present invention is generally related to messaging systems and more particular to a messaging system providing communication to at least a correspondent while tracking the correspondent's location simultaneously.

### (b) Description of the Prior Art

Messaging is a common requirement in the daily life. Especially in this Internet era when everyone possesses a mobile phone, people are constantly communicating with each other through various messaging systems. Existing messaging systems provide text, audio, or video communications. To know the location of the other party, he or she has to reveal his/her location through text, audio, or video messages. Not only the location revealed in this way is inaccurate, but also the distance and estimated time for meeting are difficult to determine.

### SUMMARY OF THE INVENTION

A major objective of the present invention is to provide a messaging system including a map unit and a messaging unit integrated in a same screen so that a local user and a correspondent may learn the whereabouts of the other party while conducting communications simultaneously.

The messaging system, therefore, includes a map unit providing and showing locations of a local user and a plurality of correspondent in a map on a screen of the local user; and a messaging unit for sending and receiving messages between the local user and a correspondent, and showing the messages on the screen along with the map. The messaging unit includes a media selection unit for the local user to choose video call, call over voice network, call over Internet, etc. If the media selection unit is not engaged to make a selection, a default mode of communication is through messaging. In this manner, the map by the map unit and a messaging window by the messaging unit are shown simultaneously on the screen. As such, the local user may learn the whereabouts of the correspondent while conducting communications with the correspondent simultaneously.

As such, the prior art's issues such as providing only text, audio, or video communications, and one has to reveal his/her location through text, audio, or video messages in a rough manner are resolved. In addition, the present invention provides not only the location of a correspondent but also the distance and estimated time for them to meet together.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings, identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a functional block diagram showing a messaging system according to an embodiment of the present invention.

FIG. 2 is a schematic diagram showing a screen of the messaging system of FIG. 1.

FIG. 3 is a schematic diagram showing another screen of the messaging system of FIG. 1 where a route for a local user and a correspondent to meet is planned and indicated.

FIG. 4 is a schematic diagram showing another screen of the messaging system of FIG. 1 where a messaging display is shown after a messaging unit is engaged.

FIG. 5 is a schematic diagram showing another screen of the messaging system of FIG. 1 where a display for a video call and a map are shown simultaneously on the screen.

FIG. 6 is a schematic diagram showing another screen of the messaging system of FIG. 1 where a message log unit is engaged to record the messages.

FIG. 7 is a schematic diagram showing another screen of the messaging system of FIG. 1 where the locations and routes of multiple correspondents are shown in the map.

### DETAILED DESCRIPTION OF THE PREFERRED EMBODIMENTS

The following descriptions are exemplary embodiments only and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

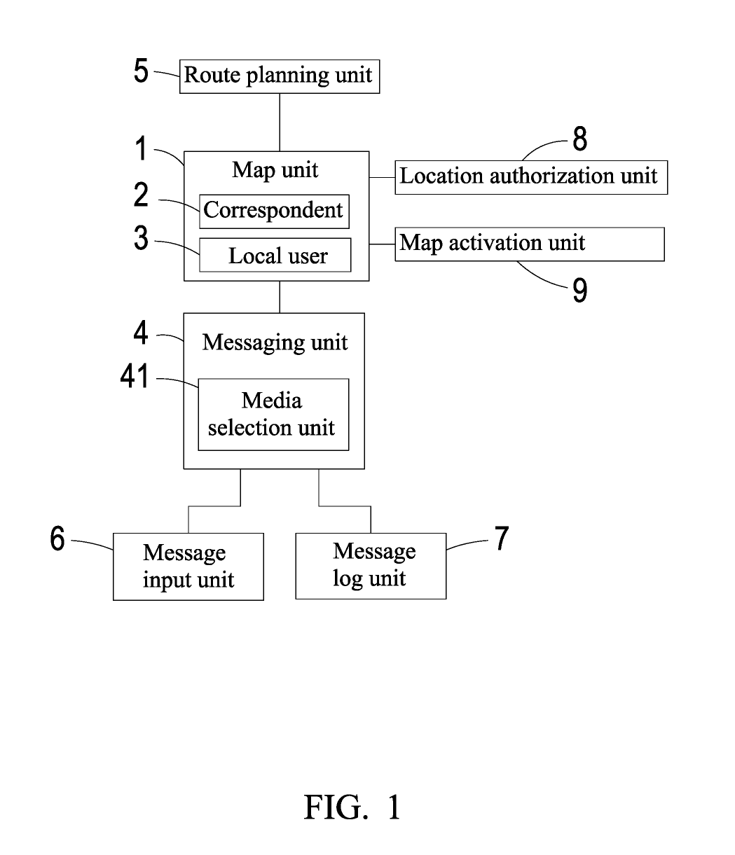

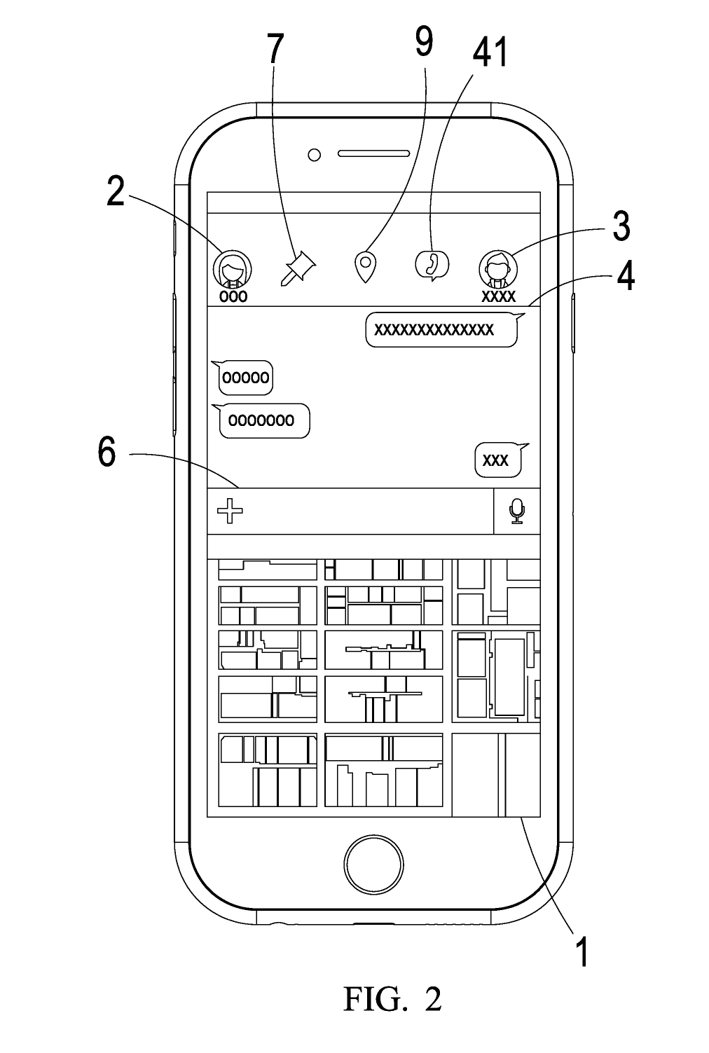

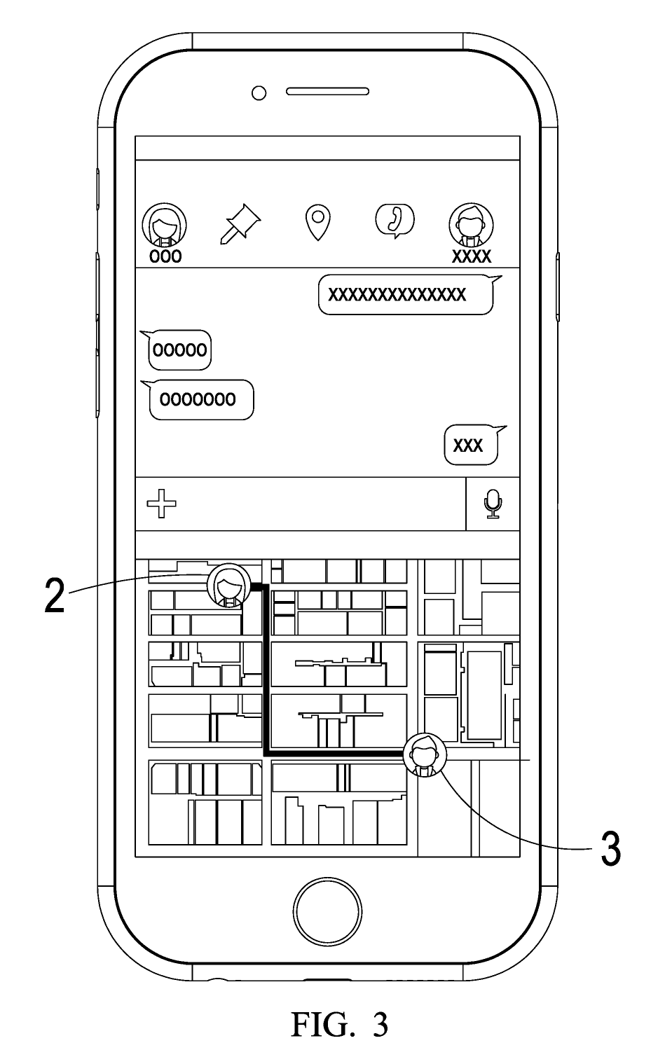

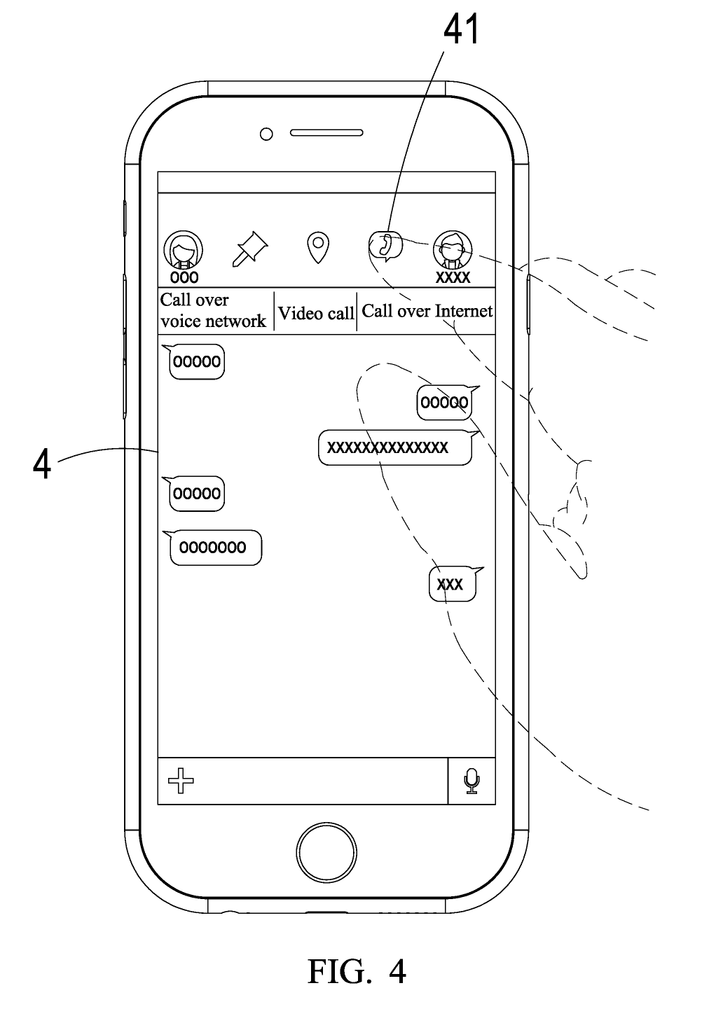

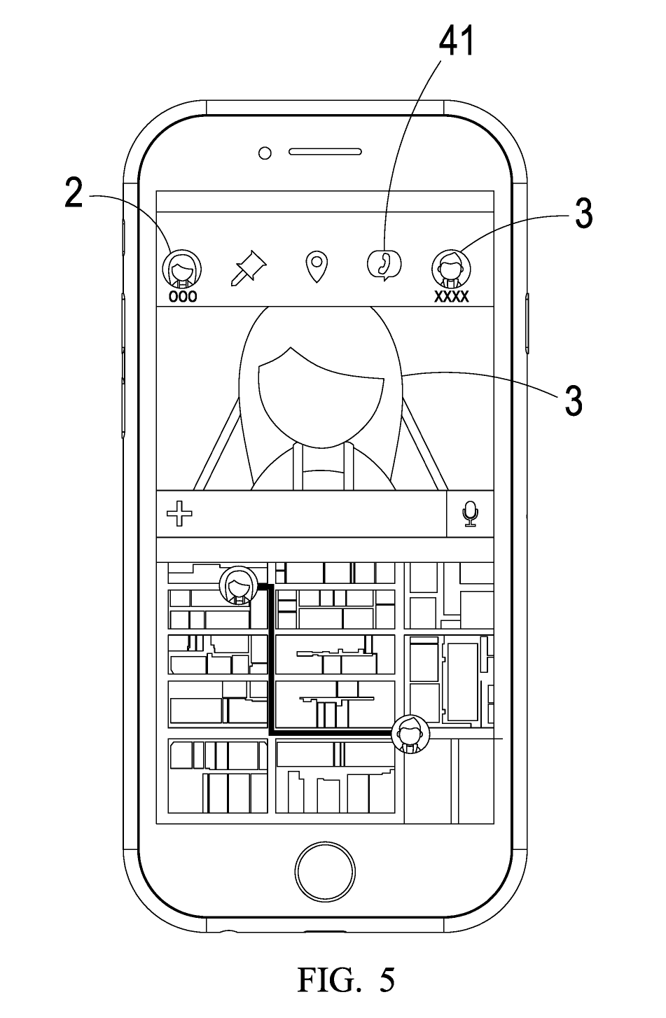

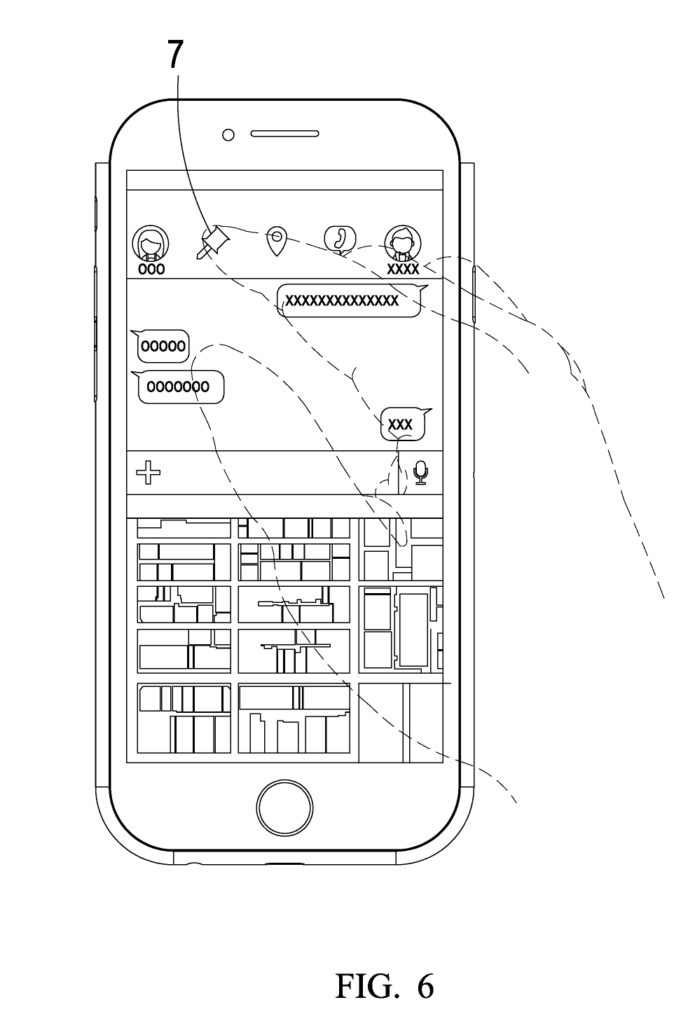

As shown in FIGS. 1 to 6, a messaging system with location tracking according to an embodiment of the present invention includes the following components.

There is a map unit 1 providing and showing the locations of a local user 3 and at least a correspondent 2 in a map on a screen of the local user 3.

There is a messaging unit 4 for sending and receiving messages (e.g., text messages, video messages, audio messages, etc.) between the local user 3 and a correspondent 2. The messaging unit 4 includes a media selection unit 41 for the local user 3 to select a type of media for communication with the correspondent 2.

There is a route planning unit 5 that determines a route between the local user 3 and the correspondent 2 for them to meet along the route. The route is displayed on the screen by the map unit 1, along with the amount of time required for them to meet, and the distances traveled, both also determined by the route planning unit 5.

There is a message input unit 6 for the local user 3 to enter messages that will be delivered to the correspondent 2 by the messaging unit 4.

There is a message log unit 7 recording the messages sent and received by the local user 3 to various correspondents 2 separately.

There is a location authorization unit 8 for the local user 3 to authorize the map unit 1 to reveal a current location of the local user 3 so that the correspondent 2 may learn the whereabouts of the local user 3.

There is a map activation unit 9 for activating the map unit 1 to show the map on the screen.

Therefore, when the local user 3 wants to communicate with a correspondent 2 and to learn where the correspondent 2 is located, the local user 3 engages the map activation unit 9 in a top section of the screen. The map unit 1 is as such activated and shows a map in a bottom half of the screen. The local user 3 then may engage the location authorization unit 8 so that the map unit 1 reveals a current location of the local user 3 that is visible to the correspondent 2. The messaging unit 4 shows the messages sent to and received from the correspondent 2 by the local user 3 in a middle section of the screen above the map. As such, the local user 3 may learn the correspondent 2's location through the map unit 1 while communicating with the correspondent 2 through the messaging unit 4 and the message input unit 6.

To find out a best route for the local user 3 and the correspondent 2 to meet, the route planning unit 5 is activated and the route is displayed on the screen in a different color or a different line style. The route planning unit 5 also determines an estimated time of meeting and estimated traversal distances for both the local user 3 and the correspondent 2. The estimated time and distances are also shown on the screen. If the local user 3 wants to conduct a video call with the correspondent 2, the media selection unit 41 is activated and a menu is available to the local user 3 to choose video call or voice call. For voice call, the menu further provides options like call over voice network, call over Internet, etc. If video call is chosen, a video display would be shown on the screen above the map so that the map would still be available while the video call is going. The local user 3 may enlarge the video display to cover the entire screen and later restore it to the original size and position. If call over Internet is chosen, the map by the map unit 1 and a text messaging window by the messaging unit 4 remain unchanged. If call over voice network is chosen, a voice call display would cover the entire screen.

Additionally, the text or graphic messages sent from and received by the local user 3 are recorded by the message log unit 7. These messages are stored separately and independently for each and every correspondent 2. The local user 3, therefore, may retrieve earlier messages with a correspondent 2 through the message log unit 7.

Furthermore, the map unit 1 may provide and show the locations of not only one but multiple correspondents 2, so that tracking the correspondents 2 is more convenient.

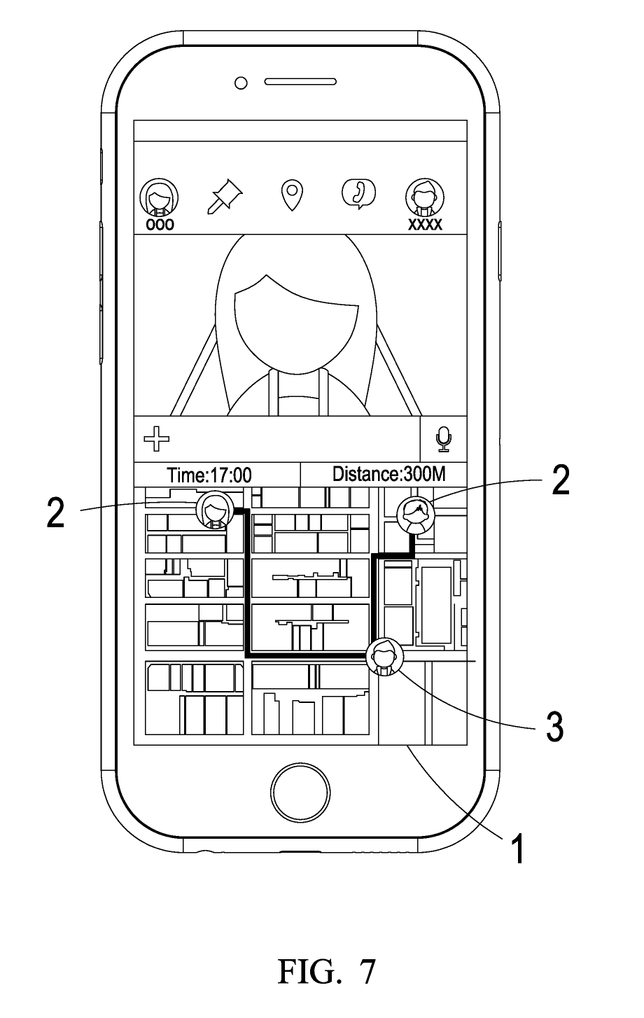

FIG. 7 provides an application scenario of the present embodiment. As illustrated, there are multiple correspondents 2 shown in the map. The map unit 1 shows the remaining times and distances between the local user 3 and the correspondents 2 in real time. The convenience of the present embodiment is therefore greatly enhanced.

The gist of the present invention lies in the following.

By integrating the map from the map unit 1 and a message window from the messaging unit 4 simultaneously in a same screen, both the local user 3 and the correspondents 2 may monitor the locations of other parties while communicating with them through the messaging unit 4 concurrently.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the claims of the present invention.

I claim:

1. A messaging system, comprising
a map unit providing and showing locations of a local user and a plurality of correspondent in a map on a screen of the local user; and
a messaging unit for sending and receiving messages between the local user and a correspondent, and showing the messages on the screen along with the map, where the messaging unit comprises a media selection unit for the local user to select a type of media for communication with the correspondent.

2. The messaging system according to claim 1, further comprising a route planning unit for determining a route between the local user and a correspondent for them to meet along the route, an amount of time required for them to meet, and the distances for them to travel, wherein the route, the amount of time, and the distances are displayed on the screen by the map unit.

3. The messaging system according to claim 1, wherein each of the messages is one of a text message, a video message, and an audio message.

4. The messaging system according to claim 3, further comprising a message input unit for the local user to enter messages to be delivered to a correspondent by the messaging unit.

5. The messaging system according to claim 1, further comprising a message log unit for recording the messages sent and received by the local user to and from the correspondents separately and respectively.

6. The messaging system according to claim 5, further comprising a location authorization unit for the local user to authorize the map unit to reveal a current location of the local user on the map so that the correspondents learn the whereabouts of the local user.

7. The messaging system according to claim 1, further comprising a map activation unit for activating the map unit to show the map on the screen.
